(19) United States
(12) Patent Application Publication
(10) Pub. No.: US 2022/0413110 A1
(43) Pub. Date: Dec. 29, 2022

(54) FREQUENCY ENCODING OF MULTIPLE IN-FLIGHT COHERENT PULSES

(71) Applicant: Seagate Technology LLC, Fremont, CA (US)

(72) Inventors: Daniel Joseph Klemme, Josephine, MN (US); Kevin A. Gomez, Minneapolis, MN (US)

(21) Appl. No.: 17/844,227

(22) Filed: Jun. 20, 2022

Related U.S. Application Data
(60) Provisional application No. 63/216,046, filed on Jun. 29, 2021.

(51) Int. Cl. G01S 7/497; G01S 17/50; G01S 17/26

(52) U.S. Cl. CPC G01S 7/497; G01S 17/50; G01S 17/26

(57) ABSTRACT

Method and apparatus for light detection and ranging (LiDAR). In some embodiments, an emitter is used to emit a set of pulses to impinge a target, and a detector is used to detect a corresponding set of reflected pulses. Range information associated with the target is extracted using the reflected pulses. To compensate for doppler shift and enable more emitted pulses to be in-flight between the system and the target, a maximum expected doppler shift is determined, and the emitted pulses are provided with differential frequency intervals that are greater than the determined maximum expected doppler shift, such as a multiple (e.g., 2×) of the maximum expected doppler shift. In some cases, each in-flight pulse will have a unique frequency separated from all other pulse frequencies by at least the maximum expected doppler shift. Adaptive adjustments can be made such as increasing the differential frequency intervals for long distance targets.

### RELATED APPLICATION

The present application makes a claim of domestic priority to U.S. Provisional Patent Application No. 63/216,046 filed Jun. 29, 2021, the contents of which are hereby incorporated by reference.

### SUMMARY

Various embodiments of the present disclosure are generally directed to a method and apparatus for performing light detection and ranging (LiDAR) using frequency encoded, in-flight coherent pulses.

Without limitation, some embodiments provide an emitter to emit a set of pulses to impinge a target, and a detector to detect a corresponding set of reflected pulses. Range information associated with the target is extracted using the reflected pulses. To compensate for doppler shift and enable more emitted pulses to be in-flight between the system and the target, a maximum expected doppler shift is determined, and the emitted pulses are provided with differential frequency intervals that are greater than the determined maximum expected doppler shift, such as a multiple (e.g., 2×) of the maximum expected doppler shift.

In some cases, each in-flight pulse will have a unique frequency separated from all other pulse frequencies by at least the maximum expected doppler shift. Adaptive adjustments can be made during operation, such as increasing the differential frequency intervals for long distance targets.

These and other features and advantages of various embodiments can be understood with a review of the following detailed description in conjunction with the accompanying drawings.

### BRIEF DESCRIPTION OF THE DRAWINGS

FIG. 1 is a block representation of a Light Detection and Ranging (LiDAR) system constructed and operated in accordance with various embodiments of the present disclosure.

FIG. 2 shows sets of emitted pulses from the system of FIG. 1 in some embodiments.

FIG. 3 provides a functional block representation of an emitter of the system of FIG. 1 in some embodiments.

FIG. 4 provides a functional block representation of a detector of the system of FIG. 1 in some embodiments.

FIG. 5 schematically depicts a transmission and decoding sequence carried out in some embodiments.

FIG. 6 is a doppler shift management system constructed and operated in accordance with some embodiments.

FIG. 7 shows aspects of a doppler shift manager circuit in further embodiments.

FIG. 8 is a range information detection sequence diagram to illustrate various operations that can be carried out by some embodiments.

FIG. 9 shows another system constructed and operated in accordance with further embodiments.

### DETAILED DESCRIPTION

Various embodiments of the present disclosure are generally directed to optimization of an active light detection system.

Light Detection and Ranging (LiDAR) systems are useful in a number of applications in which range information (e.g., distance, etc.) is determined by radiating a target with electromagnetic radiation in the form of light. The range information is detected in relation to the waveform and timing characteristics of reflected light received back by the system. LiDAR applications include topographical mapping, guidance, surveying, and so on. One increasingly popular application for LiDAR is in the area of autonomously piloted or driver assisted vehicle guidance systems (e.g., self-driving cars, autonomous drones, etc.). While not limiting, the light wavelengths used in a typical LiDAR system may range from ultraviolet to near infrared (e.g., 250 nanometers, nm to 1000 nm or more).

One commonly employed form of LiDAR is sometimes referred to as coherent pulsed LiDAR, which generally uses coherent light and detects the range based on detecting phase differences in the reflected light. Such systems may use a dual (I/Q) channel detector with an I (in-phase) channel and a Q (quadrature) channel.

While operable, these and other forms of LiDAR systems can have difficulty providing a desired level of resolution, particularly at longer distances between the LiDAR system and the target.

Various embodiments of the present disclosure enhance such resolution by providing a LiDAR detection system with enhanced emitter and detector capabilities. As explained below, some embodiments encode frequency differences in sets of emitted pulses to enable a higher number of in-flight pulses. Doppler shift effects will affect the frequencies of the emitted and returned pulses. Such doppler shift is expected to be below some upper threshold, however, so providing the pulses with shifts greater than this threshold will allow the pulses to be cleanly and accurately disambiguated from each other to provide accurate range information (e.g., distance, speed, surface characteristics, relative location, color, shape, etc.). It will be appreciated that excessive amounts of doppler shift may affect the color spectra and/or shape of the pulses, but these factors may not be significant or can be compensated.

In some embodiments, a maximum amount of doppler shift that can be expected to occur is measured or estimated. This maximum amount of doppler shift can be based on a number of factors including expected detection range, operational frequency (wavelength) of the emitted pulses, environmental conditions, maximum expected relative velocity between detector and target, and so on.

The maximum expected doppler shift value is combined with a scaling factor to provide a desired margin interval, which is then used as a minimum separation differential between the frequencies of successive pulses in each emitted pulse set. The scaling factor can be any suitable value such as but not limited to 1.5×, 2×, 3×, etc. In some embodiments, the scaling factor will be greater than one (1) and will be multiplied by the maximum expected doppler shift to provide the final margin interval, although other arrangements can be used.

In one example, assume that based on a particular set of operating conditions the maximum doppler shift is expected to be around +/−100 MHz (megahertz, 10⁶ Hz) or below. Using a scaling factor of two (2) provides interval differential values of +/−200 MHz, so frequency shifts among the successive pulses in steps of 200 MHz or more will be more than sufficient to differentiate the pulses during detection operations.

In further embodiments, different operational modes can be identified and selected to provide different levels of margin. For example, detection circuity may operate to determine that a long range target condition is being experienced, so that the system adaptively employs a different frequency modulation profile to enhance resolution of the distal target.

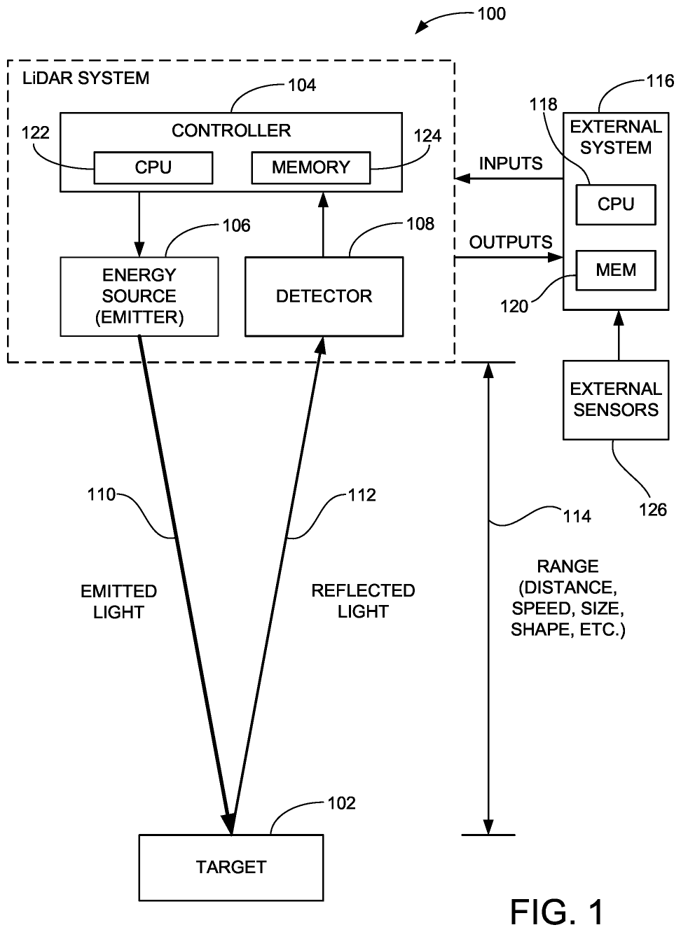

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118. External sensors 126 can provide further inputs used by the external system 116 and/or the LiDAR system 100.

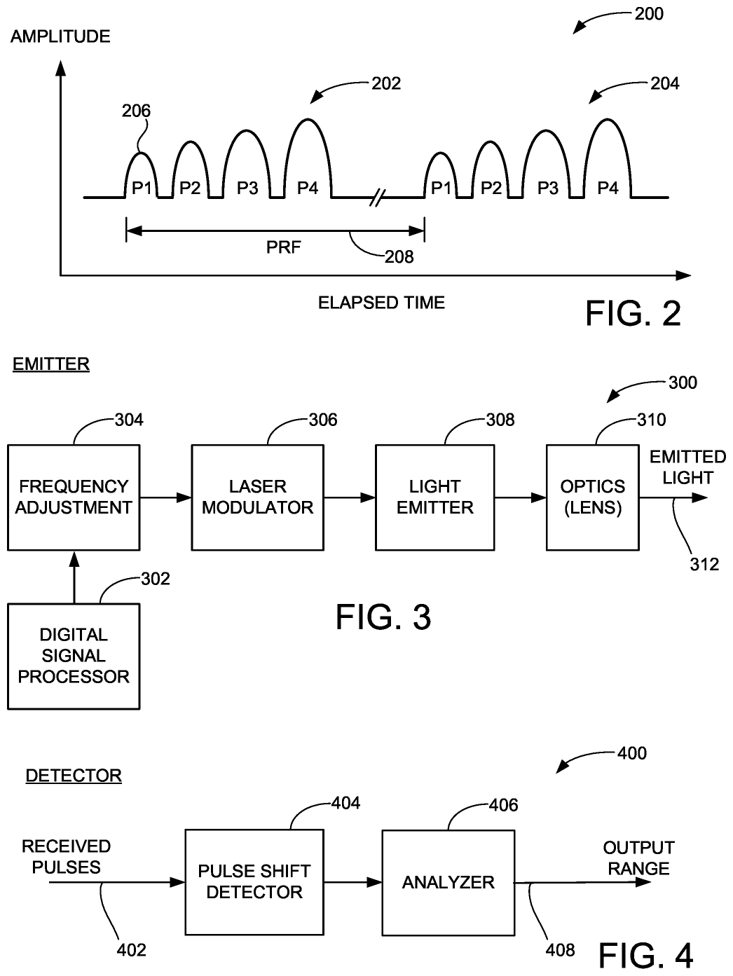

FIG. 2 is a graphical representation of emitted light pulses 200 supplied by the emitter of FIG. 1 in some embodiments. It will be appreciated that FIG. 2 is merely illustrative and is not limiting as any number of configurations can be used based on the present disclosure.

Two successive sets of pulses are shown at 202 and 204, with each set having four (4) successive pulses 206 denoted as pulses P1-P4. Each of the pulses P1-P4 in each set is provided with an encoded characteristic to enable the detector to differentiate the respective pulses and gain more pulses in-flight at any given time. In this case, each pulse is contemplated as being supplied with a successively different frequency. Different amplitudes for the pulses are shown to better distinguish the pulses, but this is merely exemplary and is not limiting. While a total of four (4) pulses are shown in each group, this is not required as other configurations can be used. The pulses are shown to have sinusoidal shapes, but substantially any suitable shape can be used, since the shape of returned pulses is not of particular significance in at least certain embodiments. The proximity of the pulses one to another in each set is exaggerated and can vary as required, but it is nonetheless contemplated that the sets of pulses will be localized groups of pulses that occur in relatively quick succession, separated by relatively long intervening intervals between successive sets.

The emitted pulses 206 will each have a frequency referred to as the center frequency of the laser, F_{C}. Pulses of the same type (e.g., the respective P1 pulses in sets 202, 204) will be emitted by the emitter 106 at a regular rate referred to as the pulse repetition frequency, or PRF (interval 208). The elapsed time for each separate pulse to travel downrange, impinge the target 102, and be reflected back to the detector 108 is referred to as the time of flight (TOF).

Based on these relations, the range R can be defined as the distance between the system 100 and the target 102. The range R can be determined as follows:

$$R = \frac{( TOF ) c}{2} \qquad ( 1 )$$

where c is the speed of light in the associated medium (e.g., atmospheric air, etc.). If f_{D} is the detected frequency of the returned pulse, then the relative velocity V between the system 100 and the target 102 can be determined as:

$$V = ( \frac{c}{2} ) ( \frac{{f}_{D}}{{f}_{C}} ) \qquad ( 2 )$$

The doppler shift f_{Δ} is defined as the amount of frequency differential between the frequency f_{C} of the emitted pulse and the frequency f_{D} of the returned pulse. This can be determined as:

f₆₆=f_{D}−f_{C} (3)

where a positive value of f_{Δ} indicates relative movement of the target toward the system and a negative value of f_{Δ} indicates relative movement of the target away from the system.

If λ_{C} is the wavelength of the emitted light pulse (e.g., λ_{C}=1/f_{C}), then the doppler shift frequency f_{Δ} can further be expressed as:

$${f}_{Δ} = \frac{V}{{λ}_{C}} \qquad ( 4 )$$

Equations (1)-(4) above, as well as other relations, can be used to identify upper bounds on the maximum expected doppler shift f_{Δ}, also referred to herein as MAXDS. A suitable scaling factor SF, such as 2×, 1.5×, 3×, etc., is applied to the MAXDS value to arrive at a minimum pulse frequency interval (MPFI), such as by:

MPFI=(SF)(MAXDS) (5)

Referring again to FIG. 2, if pulse P1 has a first frequency X, then pulse P2 will have a second frequency Y such that

Y≥(X)±(MPFI) (6)

In one nonlimiting example, assume the LiDAR system 100 of FIG. 1 is for an automobile application to provide assistance to a human driver of the vehicle (e.g., cruise control, automated braking, collision alarm/avoidance, etc.). In such case, factors used to calculate an expected MAXDS value, and from that an appropriate MPFI value, may include the top expected or available speed that the vehicle is observed to be or expected to be driven, the top expected or available speed(s) of approaching vehicles, the operational range distance over which the system is desired to operate, desired resolution characteristics, operational conditions (e.g., rain, fog, etc.), the wavelength range capabilities of the emitter, etc. Other factors and considerations can be used.

FIG. 3 shows a functional block representation of an emitter 300 that generally corresponds to the emitter 106 in FIG. 1 and which is configured to operate in accordance with the foregoing discussion. Other arrangements can be used.

A digital signal processor (DSP) provides control inputs to a frequency and phase adjustment circuit 304. While adjustments in frequency are contemplated, it will be understood that other encoding mechanisms can be additionally and/or alternatively supplied to differentiate the pulses, such as adjustments in phase, amplitude, etc. The circuit 304 may take the form of an adaptively programmable oscillator, a voltage controlled oscillator (VCO), a variable tuned clocking circuit, etc.

Outputs from the circuit 304 are provided to a laser modulator 306, which in turn directs a light emitter 308 to emit, via a suitable optics (e.g. lens) arrangement 310, emitted light pulses 312 generally corresponding to those shown in FIG. 2.

The system 300 of FIG. 3 can be adaptively adjusted based on detection outputs provided by a detector 400 shown in FIG. 4. It will be appreciated that the detector 400 can have various upstream components (not separately shown), including receiving optics, amplification circuitry, mixers (including I and Q channel mixers), low pass filtering, analog to digital conversion, etc.

The received and processed pulses, denoted at 402, are supplied to a pulse shift detector circuit 404 which differentiates among the received pulses reflected back from the distal target. In this way, the circuit 404 will be able to distinguish whether a particular pulse is P1-P4, etc. in a given pulse set. An analyzer circuit 406 uses the information from the differentiated pulses to output the desired range information 408.

As noted above, the techniques described herein enable the system to maintain significantly higher numbers of in-flight pulses to gain greater resolution of distal targets while compensating for doppler effects based on such distance.

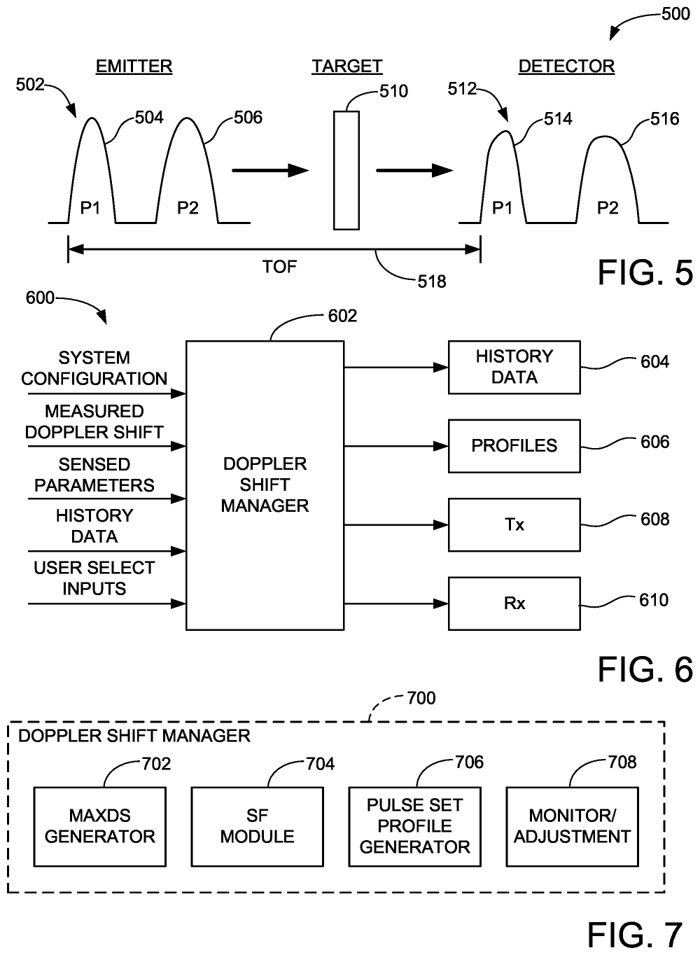

The manner in which the detector circuit 400 decodes range information from sets of received pulses can be understood with a review of FIG. 5, which is a simplified graphical flow diagram of a pulse transmission and reflection sequence 500. An initial set of pulses is depicted at 502. This initial set of pulses 502 has two pulses 504, 506 denoted as P1 and P2. Each pulse has an associated frequency separated by a selected differential frequency interval that meets or exceeds the MPFI value in accordance with equation (6) above.

The emitted pulses 504, 506 are quanta of electromagnetic energy that are transmitted downrange toward a target 510. Reflected from the target is a received set of pulses 512, which has two corresponding pulses 514 (pulse P1) and 816 (pulse P2). The time of flight (TOF) value for pulse P1 is denoted at 518. Similar TOF values are provided for each pulse in turn.

The received P1 pulse 514 will likely undergo frequency doppler shifting and other distortions as compared to the emitted P1 pulse 504. The same is generally true for each successive sets of transmitted and received pulses such as the P2 pulses 506, 516. Nevertheless, the frequencies of the received pulses 514, 516 will be sufficiently distinct to enable the detector circuit 400 to correctly match the respective pulses, allowing for accurate decoding of the desired range information. Because of this frequency differentiation, many more pulses can be in transit at a time as compared to conventional systems, providing more energy on the target and hence, higher resolution output by the detector.

FIG. 6 shows a doppler shift management system 600 that can be incorporated into the system 100 of FIG. 1 in some embodiments. The system 600 includes a doppler shift manager circuit 602 which operates to implement doppler shift compensated LiDAR sensing as described above. The manager circuit 602 can be incorporated into the controller 104 such as a firmware routine stored in the local memory 124 and executed by a controller processor 122.

The manager circuit 602 uses a number of inputs including system configuration information, measured doppler shift during previous operations, various other sensed parameters from the system (including external sensors 126), history data accumulated during prior operation, and user selectable inputs. Other inputs can be used as desired.

The manager circuit 602 uses these and other inputs to provide various outputs including accumulated history data 604 and various profiles 606, both of which can be stored in local memory such as 124 for future reference. The history data 604 can be arranged as a data structure providing relevant history and system configuration information. The profiles 606 can describe different pulse set configurations with different numbers of pulses at various frequencies and other configuration settings.

The manager circuit 602 further operates to direct various control information to an emitter (transmitter Tx) 608 and a detector (receiver Rx) 610 to implement these respective profiles. It will be understood that the Tx and Rx 608, 610 correspond to the various emitters and detectors described above.

FIG. 7 shows a functional block representation of a doppler shift manager circuit 700 similar to the manager circuit 602 of FIG. 6 in some embodiments. A MAXDS generator circuit 702 operates to identify a currently appropriate MAXDS value, which can be directly measured using calibration or operational pulses or calculated using the various equations provided above.

An SF module 704 provides circuitry to select an appropriate scaling factor SF value for current operation. While a default value such as 2X may be appropriate in many cases, other values can be used to provide a greater or lesser amount of margin.

A pulse set profile generator circuit 706 operates to select the various characteristics for a given pulse set, such as number of pulses, frequency for each pulse, time between pulses, PRF values from one set to the next set, amplitude values, shape and waveform characteristics, raster pattern, and so on.

These and other aspects of the profile can be forwarded to the emitter (Tx 608) and the detector (Rx 610) for implementation. In some cases, the profile may be a selected number of sets with different pulse characteristics that are cyclically applied and adjusted as required. In other cases the system is configured such that no pulse is in flight at a given time will have the same nominal frequency (or a frequency within the minimum interval MPFI).

Finally, a monitor/adjustment circuit 708 monitors ongoing emission and detection performance and adaptively adjusts the system accordingly. Exception data can be incorporated into the data log 604 for diagnostics and future reference during operation.

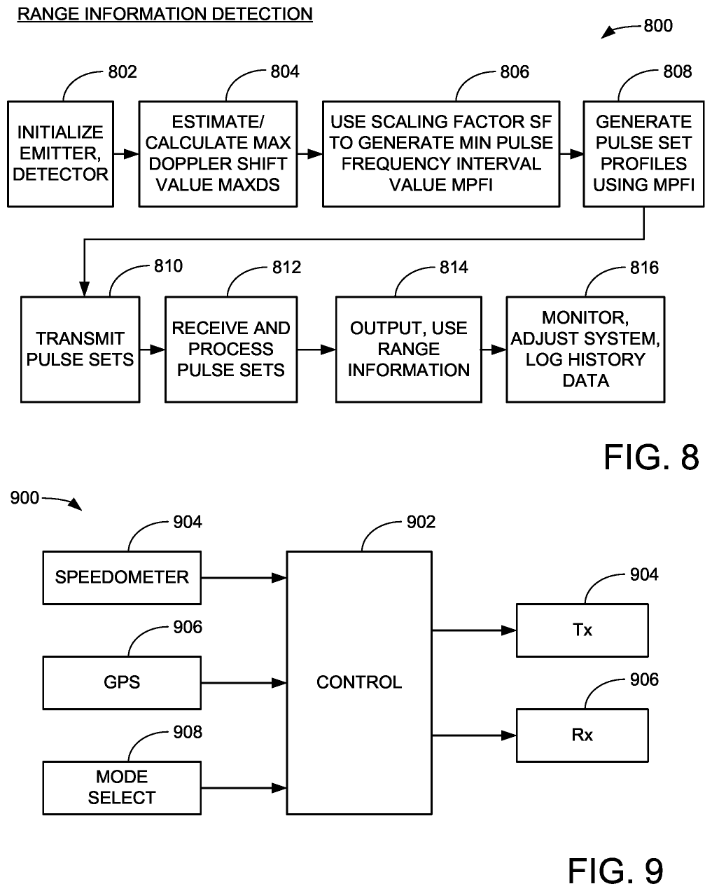

FIG. 8 provides a range information detection sequence 800 to illustrate steps that can be carried out in accordance with the foregoing discussion. It will be appreciated that other operations can be incorporated into the sequence as desired.

The system 100 is initialized at block 802 to place the system into an operationally ready state. This can be responsive to an activation signal from the external system 116.

A MAXDS value is estimated or otherwise determined as described above at block 804, and a scaling factor SF is applied to the MAXDS value to determine a suitable MPFI value at block 806. A pulse set profile based on the determined MPFI value is next generated at 808, and pulse sets corresponding to the profile are transmitted at block 810.

The transmitted pulse sets impinge the target, are reflected back and received for processing as described above at block 812. The detector circuitry outputs the corresponding range information for use as required at block 814. The foregoing cycling continues while the manager circuitry monitors and implements adaptive adjustments, as well as accumulates history data, at block 816.

FIG. 9 shows another system 900 constructed and operated in accordance with various embodiments. To provide a concrete example, the system 900 is incorporated into an automobile and provides doppler shift compensated LiDAR capabilities as set forth above including aspects shown in FIG. 1.

A main control circuit 902 receives various inputs including a vehicle speed from a speedometer 904, geolocation information from a global positioning system (GPS) system 906, and user or system directed mode selection inputs from a mode select device 908. Responsive to these and other inputs, profile information is communicated to respective Tx and Rx systems 904, 906. Selection inputs can include observed operational speed and range data, amounts of detected doppler shift, desired or observed ranges, etc. For example, if the system detects the vehicle is operating at highway speeds such as on an interstate highway, longer range targets may become of higher significance and adjustments made automatically by the system.

While coherent, I/Q based systems have been contemplated as a basic environment in which various embodiments can be practiced, such are not necessarily required. Rather, any number of different types of systems can be employed, including solid state, mechanical, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method, comprising:
determining a maximum expected doppler shift for pulses transmitted to and reflected from a target;
emitting, from an emitter, a set of emitted pulses to impinge the target, the set of emitted pulses comprising first and second emitted pulses having a differential frequency interval therebetween selected to be greater than the determined maximum expected doppler shift;
receiving, by a detector, a corresponding set of reflected pulses from the target comprising a first reflected pulse corresponding to the first emitted pulse and a second reflected pulse corresponding to the second emitted pulse; and
extracting, by a control circuit, range information associated with the target responsive to the set of emitted pulses and the set of reflected pulses.

2. The method of claim 1, further comprising adjusting the differential frequency interval to a greater or lower second differential frequency interval between first and second emitted pulses in a subsequently emitted second set of emitted pulses responsive to the extracted range information.

3. The method of claim 1, further comprising generating the differential frequency interval between the first and second emitted pulses by generating a minimum pulse frequency interval (MPFI) value through a combination of the determined maximum expected doppler shift and a predetermined scaling factor, providing the first emitted pulse with a first frequency magnitude, and providing the second emitted pulse with a second frequency magnitude that is either greater or less than the first frequency magnitude by at least a magnitude of the MPFI value.

4. The method of claim 3, wherein the scaling factor is a value of 2 or greater so that the differential frequency interval between the first and second emitted pulses is at least twice the maximum expected doppler shift, thereby enabling the control circuit to uniquely identify and match the respective emitted and received pulses.

5. The method of claim 1, wherein the first reflected pulse has a first amount of doppler shift in frequency as compared to the first emitted pulse, wherein the second reflected pulse has a second amount of doppler shift in frequency as compared to the second emitted pulse, and wherein both the first and second amounts of doppler shift in frequency are less than the maximum expected doppler shift to enable the control circuit to match the first reflected pulse to the first emitted pulse and to match the second reflected pulse to the second emitted pulse.

6. The method of claim 1, wherein a plurality of emitted pulses are concurrently in flight between the emitter and the target, wherein each of the plurality of emitted pulses has a unique associated frequency, and the unique associated frequencies of any pair of the plurality of emitted pulses are different by an amount greater than the maximum expected doppler shift.

7. The method of claim 1, wherein the determining step comprises measuring a doppler shift amount between a set of calibration pulses and using the measured doppler shift amount to determine the maximum doppler shift.

8. The method of claim 1, wherein the determining step comprises estimating the maximum doppler shift responsive to at least one of an estimated distance to the target, a frequency range of a laser source of the emitter, or an expected maximum relative velocity between the emitter and the target.

9. The method of claim 1, wherein the range information comprises a distance from the detector to the target determined responsive to a time of flight interval from the emitting of the first emitted pulse to detection of the first received pulse.

10. The method of claim 1, wherein the range information comprises a relative velocity between the emitter and the target determined responsive to a detected difference in a frequency of the first emitted pulse and a frequency of the first received pulse.

11. The method of claim 1, further comprising generating a profile that describes a succession of pulses to be emitted cyclically by the emitter in turn, and using the profile to generate the set of emitted pulses and to process the set of received pulses, the succession of pulses having frequencies separated by a multiple of the determined maximum doppler shift.

12. The method of claim 1, further comprising subsequent steps of measuring an actual amount of doppler shift between the respective sets of emitted and received pulses, and repeating the determining, emitting, receiving and extracting steps using the actual amount of doppler shift as a new maximum expected doppler shift.

13. The method of claim 1, wherein the emitter uses a laser light source to generate the set of emitted pulses, and the detector uses an I/Q channel to process the set of received pulses.

14. An apparatus comprising:
an emitter configured to use a light source to emit sets of pulses toward a target;
a detector configured to decode reflected sets of pulses from the target corresponding to the emitted sets of pulses to determine range information associated with the target; and
a controller circuit configured to determine a maximum expected doppler shift (MAXDS) value for said emitted and reflected sets of pulses and to direct the emitter to emit a compensated set of pulses comprising a succession of pulses each having a frequency different from remaining frequencies in the succession of pulses by an intervening amount that is at least twice the MAXDS value.

15. The apparatus of claim 14, wherein the controller circuit determines the maximum expected doppler shift based on system configuration information associated with at least a selected one of the emitter, the detector or the target.

16. The apparatus of claim 14, wherein the controller circuit determines the maximum expected doppler shift based on a prior determination of a distance between the emitter and the target.

17. The apparatus of claim 14, wherein the controller circuit generates a minimum pulse frequency interval (MPFI) value by applying a scaling factor (SF) to the MAXDS value, and wherein the controller selects the frequency of each of the succession of pulses in the compensated set of pulses so that two closest frequencies are separated by at least the MPFI value.

18. The apparatus of claim 14, wherein the controller circuit further directs the detector to receive and process a compensated set of reflected pulses responsive to the emitting of the compensated set of pulses by the emitter to determine range information associated with the target.

19. The apparatus of claim 14, wherein the controller circuit further generates an updated MAXDS value and directs the emitter to emit a second compensated set of pulses comprising a succession of pulses each having a frequency different from remaining frequencies in the succession of pulses by an intervening amount that is at least twice the updated MAXDS value.

20. The apparatus of claim 14, characterized as a light detection and ranging (LiDAR) system.
